(19) United States
(12) Patent Application Publication
(10) Pub. No.: US 2026/0146722 A1
(43) Pub. Date: May 28, 2026

(54) LIGHT-EMITTING DEVICE AND LIGHTING APPARATUS

(71) Applicant: Stanley Electric Co., Ltd., Tokyo (JP)

(72) Inventor: Kaori TACHIBANA, Tokyo (JP)

(73) Assignee: Stanley Electric Co., Ltd., Tokyo (JP)

(21) Appl. No.: 19/390,786

(22) Filed: Nov. 17, 2025

(30) Foreign Application Priority Data
Nov. 25, 2024 (JP) 2024-204505

(51) Int. Cl. F21S 41/176; F21S 41/148; F21S 41/25; F21S 41/32

(52) U.S. Cl. CPC F21S 41/176; F21S 41/148; F21S 41/25; F21S 41/32

(57) ABSTRACT

A light-emitting device includes a substrate, a light-emitting unit, an optical function unit, and a light-reflecting unit. The light-emitting unit includes a light-emitting element that is arranged on the substrate and includes a light-emitting layer. Light emitted from the light-emitting layer is emitted outward from an upper surface of the light-emitting unit. The optical function unit includes a base portion and a supporting portion. The base portion forms a void between the upper surface of the light-emitting unit and has an optical element structure that allows a light emitted outward from the light-emitting unit to pass therethrough. The supporting portion extends from the base portion to a surrounding region of a region where the light-emitting element is arranged. A light-reflecting covers a side surface of the light-emitting unit and a surface of the supporting portion on the substrate.

### CROSS-REFERENCE TO RELATED APPLICATION

The present application is based upon and claims the benefit of priority from the prior Japanese Patent Application No. 2024-204505 filed on Nov. 25, 2024, the entire contents of which are incorporated herein by reference.

### BACKGROUND

### 1. Technical Field

The present invention relates to a light-emitting device including a light-emitting element and a lighting apparatus including the light-emitting device.

### 2. Description of the Related Art

A light-emitting device that uses a light-emitting element, such as a light-emitting diode (LED), as a light source has been known. For example, WO 2024/128324 discloses a light-emitting device that includes a light-emitting element, a wavelength conversion member arranged on the light-emitting element, a light-reflecting member that covers a side surface of the light-emitting element and a side surface of the wavelength conversion member, and an optical function unit including a lens arranged on the wavelength conversion member.

### SUMMARY

In the light-emitting device described in WO 2024/128324, the optical function unit is disposed adhesively on an upper surface of the light-reflecting member made of resin. For example, uncured resin that becomes the light-reflecting member is arranged on a surface, and after it is cured, a dent or distortion may be caused on the surface by what is called a resin sink mark.

If the optical function unit is bonded to the light-reflecting member with a dent or distortion on the surface, for example, a posture of the optical function unit may be different from its intended mounting posture. If such a situation occurs, the optical function unit may cause an optical axis misalignment or fail to perform an optical function well by rotating in a two-dimensional or three-dimensional direction, and desired light may not be obtained from the light-emitting device, eventually leading to a decrease in an optical output.

The present invention has been made in consideration of the above-described points, and an object of the present invention is to provide a light-emitting device that allows obtaining desired light while stably disposing an optical function unit and a lighting apparatus including the light-emitting device.

A light-emitting device according to the present invention includes a substrate, a light-emitting unit, an optical function unit, and a light-reflecting unit. The light-emitting unit includes a light-emitting element that is arranged on the substrate and includes a light-emitting layer. A light emitted from the light-emitting layer is emitted outward from an upper surface of the light-emitting unit. The optical function unit includes a base portion and a supporting portion. The base portion is disposed to form a void between the base portion and the upper surface of the light-emitting unit and having an optical element structure that allows a light emitted outward from the light-emitting unit to pass therethrough. The supporting portion extends from the base portion to a surrounding region of a region where the light-emitting element is arranged. A light-reflecting unit has a light reflectivity or a light-shielding property and covers a side surface of the light-emitting unit and a surface of the supporting portion on the substrate.

### BRIEF DESCRIPTION OF THE DRAWINGS

FIG. 1 is a top view of a light-emitting device according to Embodiment 1;

FIG. 2 is a cross-sectional view of the light-emitting device according to Embodiment 1;

FIG. 3 is a cross-sectional view illustrating an exemplary manufacturing process of the light-emitting device according to Embodiment 1;

FIG. 4 is a cross-sectional view illustrating the exemplary manufacturing process of the light-emitting device according to Embodiment 1;

FIG. 5 is a cross-sectional view of a light-emitting device according to Modification 1 of Embodiment 1;

FIG. 6 is a cross-sectional view of a light-emitting device according to Modification 2 of Embodiment 1;

FIG. 7 is a cross-sectional view of a light-emitting device according to Modification 3 of Embodiment 1;

FIG. 8 is a top view of a light-emitting device according to Modification 4 of Embodiment 1;

FIG. 9 is a cross-sectional view of a light-emitting device according to Modification 5 of Embodiment 1;

FIG. 10 is a top view of a light-emitting device according to Modification 6 of Embodiment 1; and

FIG. 11 is a cross-sectional view of a lighting apparatus as an application example of the light-emitting device according to Embodiment 1.

### DETAILED DESCRIPTION

The following describes an embodiment of the present invention in detail. Note that the same reference numerals are given to substantially identical or equivalent parts in the following description and the accompanying drawings.

### Outline of Light-Emitting Device 100

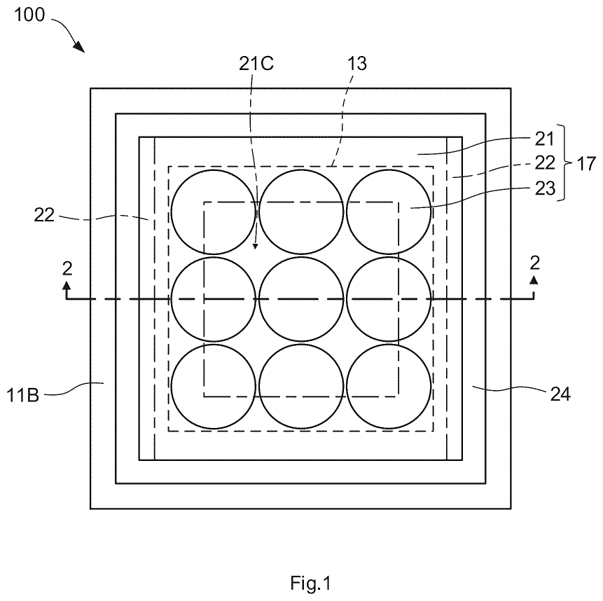

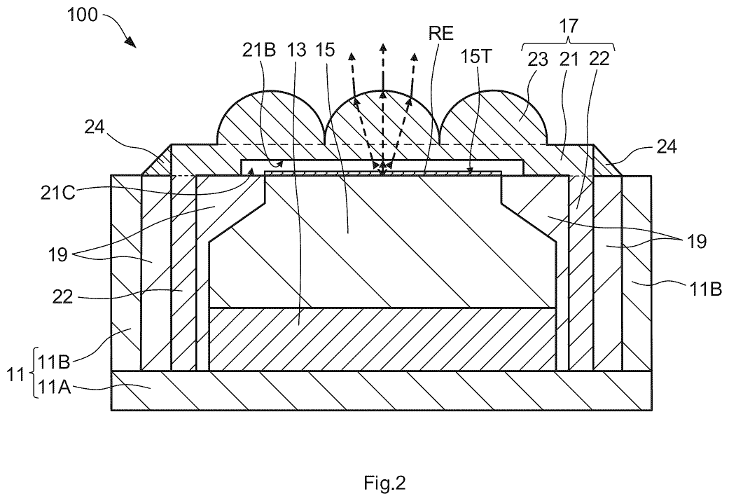

With reference to FIG. 1 and FIG. 2, a configuration of a light-emitting device 100 according to Embodiment 1 is described. FIG. 1 is a top view of the light-emitting device 100 according to Embodiment 1. FIG. 2 is a cross-sectional view along the line 2-2 of the light-emitting device 100 illustrated in FIG. 1.

The light-emitting device 100 is configured to include a substrate 11, a light-emitting element 13 arranged on the substrate 11, a phosphor unit 15 arranged on the light-emitting element 13, an optical function unit 17 arranged on the phosphor unit 15, and a light-reflecting member 19.

In FIG. 1, the outer shape line of the light-emitting element 13 is indicated by a dashed line, and a recessed portion 21C and supporting portions 22 of the optical function unit 17, which will be described later, are indicated by dash-dotted lines. In the description with reference to FIG. 2, an up-down direction in the drawing is a height direction of the light-emitting device 100, and a left-right direction in the drawing is a width direction of the light-emitting device 100.

### Substrate 11

The substrate 11 is an insulating structure constituted of a flat plate-shaped bottom portion 11A with a rectangular upper surface shape and a frame-shaped frame body portion 11B formed along an outer edge of an upper surface of the bottom portion 11A and exposing a central region of the upper surface of the bottom portion 11A. In other words, the substrate 11 is a concave body having a recessed portion with the central region of the upper surface of the bottom portion 11A as a bottom surface.

The substrate 11 is made of ceramic, such as aluminum nitride (AlN) and alumina (Al₂O₃). The substrate 11 may be formed such that the bottom portion 11A and the frame body portion 11B are integrally formed to have a recessed portion that opens upward.

### Light-Emitting Element 13

The light-emitting element 13 is a light-emitting diode (LED) having a rectangular upper surface shape and a semiconductor structure layer including a light-emitting layer formed in an approximately central region of the upper surface of the bottom portion 11A of the substrate 11.

In the light-emitting device 100, the light-emitting element 13 is constituted of a gallium nitride (GaN)-based semiconductor structure layer. When the light-emitting element 13 is driven, blue light with a peak wavelength of, for example, 450 nm is emitted from the above-described light-emitting layer.

The light-emitting element 13 includes a translucent growth substrate (not illustrated), a semiconductor structure layer formed on a lower surface of the growth substrate, and a pair of element electrodes (not illustrated) electrically connected to the semiconductor structure layer. Each of the pair of element electrodes is electrically joined to a corresponding one of a pair of wiring electrodes (not illustrated) formed on the upper surface of the bottom portion 11A of the substrate 11. That is, the light-emitting element 13 is flip-chip mounted on the bottom portion 11A of the substrate 11. The light-emitting element 13 may be mounted via wire bonding.

The light-emitting element 13 can be energized by receiving the supply of electric power from an external power supply via the pair of wiring electrodes disposed on the substrate 11. When the light-emitting element 13 is supplied with electric power and driven, the above-described blue light is emitted outward from the upper surface of the light-emitting element 13.

### Phosphor Unit 15

The phosphor unit 15 is a phosphor layer that has a rectangular upper surface shape and is joined to the upper surface of the light-emitting element 13 via a transparent adhesive (not illustrated). When the light-emitting element 13 is mounted via wire bonding, a lower surface of the phosphor unit 15 is placed in a light-emitting region of the light-emitting element 13. Here, the light-emitting region refers to a region of the upper surface of the light-emitting element 13 where a light is emitted.

The phosphor unit 15 is formed to be narrowed from the lower surface toward an upper side. Specifically, the phosphor unit 15 is configured by integrally forming a quadrangular prism-shaped lower part, a truncated square pyramid-shaped middle part, and a quadrangular prism-shaped upper part. The lower part extends in a perpendicular direction from the upper surface of the light-emitting element 13. The middle part is formed on the lower part and has inclined surfaces that are inwardly inclined on the side surfaces. The upper part is formed on the middle part.

Here, the side surfaces of the middle part of the phosphor unit 15 may be inclined surfaces with curvature. The phosphor unit 15 may have a three-dimensional shape formed of rectangular surfaces, such as a cube or a cuboid, in addition to the narrowing shape described above.

The phosphor unit 15 is formed of a phosphor that is excited by the blue light emitted outward from the light-emitting element 13 to emit fluorescence. The phosphor unit 15 is, for example, a transparent ceramic phosphor plate made of yttrium aluminum garnet (YAG:Ce) phosphor with cerium (Ce) as an activator agent.

In the phosphor unit 15, the fluorescence emitted when the phosphor is excited by blue light has a broad green to orange wavelength range from 480 nm to 700 nm and a yellow peak wavelength of 520 nm to 570 nm.

When the blue light emitted outward from the light-emitting element 13 enters the phosphor unit 15, part of the light directly passes through the phosphor unit 15, and part of the light excites the phosphor, thereby emitting fluorescence from the excited phosphor.

Therefore, the excitation light that has passed through the phosphor unit 15 without contributing to the generation of fluorescence and the fluorescence emitted from the phosphor are emitted outward from an upper surface 15T of the phosphor unit 15. As a result, white light with a mixture of blue light and yellow fluorescence is emitted outward from the upper surface 15T of the phosphor unit 15. In the light-emitting device 100 of the embodiment, the light-emitting element 13 and the phosphor unit 15 function as a light-emitting unit.

On the upper surface 15T of the phosphor unit 15, a coating layer RE with translucency over the upper surface is formed. The coating layer RE is made of a material with low affinity for an uncured resin material that becomes the light-reflecting member 19 after curing, such as fluororesin.

In addition, an optical multilayer film or a glass film may be used for the coating layer RE. As for a film thickness of the coating layer RE, a desired film thickness corresponding to each material and application can be set. The coating layer RE can also be formed over the upper surface 15T of the phosphor unit 15 and an upper surface of the light-reflecting member 19.

### Optical Function Unit 17

The optical function unit 17 as an optical element is a structure arranged on the phosphor unit 15 so as to cover the upper surface 15T of the phosphor unit 15. The optical function unit 17 is constituted of a base portion 21, supporting portions 22 extending downward from the base portion 21 and supporting the base portion 21 relative to the substrate 11, and a plurality of projecting portions 23 formed on an upper surface of the base portion 21.

The base portion 21 of the optical function unit 17 is a translucent plate-shaped part with a rectangular upper surface shape. The base portion 21 has a recessed portion 21C recessed more at a center of a lower surface of the base portion 21 than at a periphery. In the light-emitting device 100 of the embodiment, the recessed portion 21C has a rectangular planar shape.

In the light-emitting device 100, the upper surface 15T of the phosphor unit 15 is separated from a bottom surface 21B of the recessed portion 21C of the base portion 21. In addition, in a top view of the light-emitting device 100 viewed from above, the bottom surface 21B of the recessed portion 21C has an area larger than an area of the upper surface 15T of the phosphor unit 15. In a specific form, an outer edge of the recessed portion 21C is formed to surround the phosphor unit 15.

The supporting portions 22 of the optical function unit 17 extend from regions along the outer edge of the lower surface of the base portion 21 to surrounding regions of a region of the upper surface of the bottom portion 11A of the substrate 11 where the light-emitting element 13 is arranged. In the light-emitting device 100 of the embodiment, the optical function unit 17 is a plate-shaped part with a light reflectivity. The supporting portions 22 are joined to the upper surface of the bottom portion 11A of the substrate 11 via an adhesive made of silicone resin (not illustrated), thereby supporting the base portion 21.

The supporting portions 22 are not necessarily formed in the regions along the outer edge of the base portion 21, and side surfaces of the supporting portions 22 may be formed on an inner side or outer side with respect to side surfaces of the base portion 21. For example, if the supporting portions 22 are formed on the outer side with respect to the side surfaces of the base portion 21, it is easier to control the height when filling the material mainly composed of uncured resin, which becomes the light-reflecting member 19, during the manufacturing of the light-emitting device 100. On the other hand, if the supporting portions 22 are formed on the inner side with respect to the side surfaces of the base portion 21, the optical function unit 17 has higher rigidity, avoiding deformation of the optical function unit 17 when the optical function unit 17 is mounted during the manufacturing of the light-emitting device 100.

As illustrated in FIG. 1, two supporting portions 22 are formed to be opposed to one another along an extending direction of two sides of the lower surface of the base portion 21 that extend in the up-down direction in the drawing. That is, the supporting portions 22 are formed so as to sandwich the light-emitting element 13 and the phosphor unit 15 in the top view.

The supporting portions 22 preferably have a hardness that does not cause breakage or the like due to shrinkage stress associated with curing of the light-reflecting member 19 when the material mainly composed of uncured resin, which becomes the light-reflecting member 19 after curing, is filled into the recessed portion of the substrate 11 and then cured during the manufacturing of the light-emitting device 100. For example, the supporting portions 22 preferably have a Shore A hardness of 50 or more.

The projecting portions 23 of the optical function unit 17 are a plurality of hemispherical lenses formed on the upper surface of the base portion 21, each of which is formed to project upward. As illustrated in FIG. 1, the projecting portions 23 are disposed on the upper surface of the base portion 21, for example, in an form with a total of nine pieces in three rows and three columns.

The forming form of the projecting portions 23 is not limited to this, and it may be an form with four pieces in two rows and two columns. If four pieces in two rows and two columns are adopted, one more projecting portion 23 may be added to a central part. If the projecting portions 23 are arranged in two rows and two columns and one projecting portion 23 is added to the central part, the light distribution characteristics of the emitted light of the light-emitting device 100 can be adjusted.

Specifically, a desired light distribution can be achieved, for example, by reducing the brightness of a light distribution component near 0° relative to an optical axis perpendicular to the upper surface 15T of the phosphor unit 15 relative to other light distribution components and adjusting the brightness of the light of the other light distribution components. Also, for example, the brightness in a narrow-angle component can be made more uniform.

The bottom surface 21B of the recessed portion 21C does not need to be flat, and in one form, it may have an uneven shape (for example, a moth-eye structure or a microlens structure). This can improve the light extraction efficiency compared to the case where the bottom surface 21B is flat.

In the light-emitting device 100, the base portion 21 and the projecting portions 23 of the optical function unit 17 are made of a transparent silicone resin (refractive index n=1.41). In addition, the supporting portions 22 of the optical function unit 17 are made of silicone resin containing titanium dioxide (TiO₂) particles as a material that reflects or scatters blue light and yellow fluorescence. That is, in the light-emitting device 100, the base portion 21 and the projecting portions 23 of the optical function unit 17 have translucency, and only the supporting portions 22 have a light reflectivity.

In the light-emitting device 100, the optical function unit 17 is configured by integrally forming the base portion 21, the supporting portions 22, and the projecting portions 23. For example, the optical function unit 17 is manufactured in a form with what is called two-color molding, in which a primary-side resin and a secondary-side resin are combined and integrally molded in a single manufacturing cycle.

Specifically, for example, for the optical function unit 17, a first mold is first set on a movable base mold, and silicone resin as the primary-side resin is filled to mold the base portion 21 and the projecting portions 23. Afterward, the first mold is removed, the base mold is moved to set a second mold, and silicone resin as the secondary-side resin containing TiO₂ particles is filled to mold the supporting portions 22. This manufactures the optical function unit 17.

In the light-emitting device 100, the light emitted outward from the upper surface 15T of the phosphor unit 15 enters the base portion 21 through the recessed portion 21C and is emitted outward from a surface of each of the projecting portions 23 to the outside of the light-emitting device 100. That is, in the light-emitting device 100, the surface of each of the projecting portions 23 of the optical function unit 17 functions as a light-emitting surface.

### Light-Reflecting Member 19

The light-reflecting member 19 is a member with a light reflectivity formed in the recessed portion of the substrate 11. The light-reflecting member 19 is filled so as to cover each of the side surfaces of the light-emitting element 13 and the phosphor unit 15 and the surfaces of the supporting portions 22 of the optical function unit 17, and expose the upper surface 15T of the phosphor unit 15.

Therefore, in the light-emitting device 100, of the optical function unit 17, only the supporting portions 22 with a light reflectivity are covered by the light-reflecting member 19, and the base portion 21 and the projecting portions 23 with translucency are exposed from the light-reflecting member 19.

In the light-emitting device 100, the light-reflecting member 19 and the lower surface of the base portion 21 of the optical function unit 17 are in contact with one another. Note that the upper surface of the light-reflecting member 19 does not necessarily need to be in contact with the lower surface of the base portion 21. For example, when a dent occurs on the surface of the light-reflecting member 19 due to a resin sink mark during curing of the light-reflecting member 19, the upper surface of the light-reflecting member 19 and the lower surface of the base portion 21 may be separated from one another due to the dent.

The light-reflecting member 19 is made of a material with reflectivity against the blue light emitted outward from the light-emitting element 13 and the yellow fluorescence emitted from the phosphor unit 15. The light-reflecting member 19 is made of silicone resin containing, for example, TiO₂ particles.

The light-reflecting member 19 reflects or scatters the light emitted from the light-emitting element 13 and the phosphor unit 15 and reaching the respective side surfaces of the light-emitting element 13 and the phosphor unit 15. As a result, the light-reflecting member 19 can suppress the leakage of the light reaching the respective side surfaces of the light-emitting element 13 and the phosphor unit 15 to the outside of the light-emitting device 100.

In a region of the upper surface of the light-reflecting member 19 on the outer side with respect to the base portion 21, a light-reflecting member 24 is formed. The light-reflecting member 24 has a frame-shaped upper surface shape and covers an outer side surface of the base portion 21. Similarly to the light-reflecting member 19, the light-reflecting member 24 is made of silicone resin containing TiO₂ particles.

For example, when the light emitted outward from the phosphor unit 15 is guided through the base portion 21 in the left-right direction in FIG. 2 and reaches the outer side surface of the base portion 21, the light-reflecting member 24 reflects or scatters the light reaching the outer side surface. This can suppress the leakage of the light reaching the outer side surface of the base portion 21 to the outside of the light-emitting device 100.

The amount of TiO₂ particles contained in the resin may be changed between the light-reflecting member 19 and the light-reflecting member 24. For example, in one form, the amount of TiO₂ particles in the light-reflecting member 19 directly in contact with the light-emitting element 13 and the phosphor unit 15 may be greater than that of the light-reflecting member 24, thereby increasing the optical reflectivity of the light-reflecting member 19.

In the light-emitting device 100, as described above, the coating layer RE made of a material with low affinity for an uncured resin material that constitutes the light-reflecting member 19 is formed over the upper surface 15T of the phosphor unit 15.

Therefore, in the light-emitting device 100, when an uncured resin material that becomes the light-reflecting member 19 after curing is filled into the recessed portion of the substrate 11, even if the filled resin crawls up to the upper surface 15T of the phosphor unit 15, the coating layer RE easily repels it.

Therefore, it is possible to suppress an uncured resin material remaining on the upper surface 15T of the phosphor unit 15 and the formation of the light-reflecting member 19 on the upper surface 15T of the phosphor unit 15 due to the curing of the uncured resin material. That is, blocking the light-emitting surface of the phosphor unit 15 by the light-reflecting member 19 can be suppressed.

### About Light Emitted Outward from Light-Emitting Device 100

Here, the light emitted outward from the light-emitting device 100 of the embodiment is described. In the light-emitting device 100, as described above, the recessed portion 21C is formed on the lower surface of the base portion 21, and the upper surface 15T of the phosphor unit 15 is separated from the bottom surface 21B of the recessed portion 21C of the base portion 21.

Therefore, a void is formed between the upper surface 15T of the phosphor unit 15 and the bottom surface 21B of the recessed portion 21C of the base portion 21. In the light-emitting device 100 of the embodiment, the formed void is filled with air (refractive index n=1.0).

Here, the void formed between the upper surface 15T of the phosphor unit 15 and the bottom surface 21B of the recessed portion 21C of the base portion 21 is a low-refractive-index portion that has a relatively lower refractive index than the base portion 21 and the projecting portions 23 of the optical function unit 17 for the light emitted outward from the upper surface 15T of the phosphor unit 15. That is, the light emitted from the upper surface 15T of the phosphor unit 15 enters the optical function unit 17, which has a higher refractive index than the void, through the void that is a low-refractive-index portion.

As illustrated by the dashed lines in FIG. 2, the light emitted outward from the upper surface 15T of the phosphor unit 15 is narrowed in angle in an optical axis direction perpendicular to the bottom surface 21B of the recessed portion 21C of the base portion 21 by Snell's law and enters the projecting portions 23. Therefore, the narrow-angle component of the light emitted outward from the light-emitting device 100 can be increased by providing the void between the upper surface 15T of the phosphor unit 15 and the bottom surface 21B of the recessed portion 21C of the optical function unit 17.

The narrow-angle component of the light emitted outward from the light-emitting device 100 in the embodiment refers to a component of light emitted outward within a range of 30° relative to the optical axis direction perpendicular to the upper surface 15T of the phosphor unit 15.

In the light-emitting device 100, as illustrated by the dash-dotted lines in FIG. 2, the light containing the above-described narrow-angle component that has entered the projecting portions 23 is further narrowed in angle by the lens effect of the surfaces of the projecting portions 23 and emitted outward from the light-emitting device 100.

Therefore, in the light-emitting device 100 of the embodiment, the narrow-angle component of the light emitted outward from the light-emitting device 100 can be increased by providing the void (low-refractive-index portion) between the upper surface 15T of the phosphor unit 15 and the bottom surface 21B of the recessed portion 21C of the base portion 21 of the optical function unit 17 and disposing the projecting portions 23 on the upper surface of the base portion 21.

### Suppression of Decrease in Optical Output of Light-Emitting Device 100

The following describes the suppression of a decrease in the optical output of the light-emitting device 100 of the embodiment. In the light-emitting device 100 of the embodiment, as described above, the supporting portions 22 of the optical function unit 17 are joined to the upper surface of the bottom portion 11A of the substrate 11.

Here, suppose that the optical function unit 17 does not include supporting portions 22, and the base portion 21 of the optical function unit 17 is joined to the light-reflecting member 19 via an adhesive. In this case, an uncured resin material, which becomes the light-reflecting member 19 after curing, is filled into the recessed portion of the substrate 11. After it is cured to form the light-reflecting member 19, the optical function unit 17 is joined to the formed light-reflecting member 19.

When the above-described uncured resin material has cured, a resin sink mark at the time of curing may cause a dent or distortion on the surface of the light-reflecting member 19 formed after curing. In other words, the surface of the light-reflecting member 19 is no longer flat.

If the optical function unit 17 is joined to the light-reflecting member 19 having such a surface via an adhesive, the posture of the optical function unit 17 may be different from its intended mounting posture. For example, there is a risk that the optical function unit 17 will be joined in a state where the bottom surface 21B of the recessed portion 21C of the base portion 21 is inclined to the upper surface 15T of the phosphor unit 15, or that a distortion (bend) will occur on the recessed portion 21C. That is, there is a risk that the mounting accuracy of the optical function unit 17 will become unstable.

If such a situation occurs, for example, the narrow-angle component of the emitted light as described above may not be obtained, or unexpected scattering or diffusion may occur due to the optical function unit 17. As a result, the desired light may no longer be obtained from the light-emitting device 100, eventually leading to a decrease in the optical output.

In the light-emitting device 100 of the embodiment, as described above, the supporting portions 22 of the optical function unit 17 are joined to the upper surface of the bottom portion 11A of the substrate 11, which is a smooth surface. That is, in the light-emitting device 100 of the embodiment, the optical function unit 17 can be disposed regardless of the surface properties of the formed light-reflecting member 19.

Therefore, with the light-emitting device 100 of the embodiment, the optical function unit 17 can be mounted more stably than the case where the base portion 21 is joined to the light-reflecting member 19. For example, the influence of a change in posture on the light emitted outward from the light-emitting device 100 can be suppressed.

Accordingly, with the light-emitting device 100 of the embodiment, the optical function unit 17 can be stably disposed. Since this allows obtaining the desired light, for example, it is possible to suppress a decrease in the optical output of the narrow-angle component of the light-emitting device 100.

In addition, for example, if the base portion 21 of the optical function unit 17 is joined to the light-reflecting member 19 via an adhesive, the adhesive used for the joining may extend to the upper surface 15T of the phosphor unit 15. In other words, there is a risk that the adhesive for joining the base portion 21 to the light-reflecting member 19 will enter the above-described void.

Moreover, if silicone resin is used as an adhesive, silicone oil of the silicone resin seeps out as a deterioration of the adhesive over time, and the seeped silicone oil may extend to the upper surface 15T of the phosphor unit 15.

If such a situation occurs, the adhesive itself or the silicone oil seeped from the adhesive may block at least part of the upper surface 15T of the phosphor unit 15. In addition, if the seeped silicone oil extends over the upper surface 15T of the phosphor unit 15 and the bottom surface 21B, for example, there is a risk that a light path of the emitted light will change, and the desired light will not be obtained from the light-emitting device 100.

In the light-emitting device 100 of the embodiment, as described above, by joining the supporting portions 22 of the optical function unit 17 to the upper surface of the bottom portion 11A of the substrate 11, which is a smooth surface, deterioration of light distribution performance due to the adhesive or silicone oil as described above can be avoided.

In the light-emitting device 100 of the embodiment, it is only necessary for the supporting portions 22 of the optical function unit 17 to have a configuration that can support the base portion 21, and the supporting portions 22 need not necessarily have a light reflectivity. That is, the supporting portions 22 may be made only of, for example, a transparent silicone resin.

Also, the supporting portions 22 do not need to be joined to the upper surface of the bottom portion 11A of the substrate 11. For example, a plate-shaped member projecting inward on an inner side surface of the frame body portion 11B may be disposed, and the supporting portions 22 may be joined to an upper surface of the plate-shaped member. That is, a plate-shaped member may be disposed separately to join the supporting portions 22.

In the light-emitting device 100 of the embodiment, the shape of the supporting portions 22 is not limited to a plate shape. For example, the supporting portions 22 may have a column shape, such as a cylindrical shape or a quadrangular prism shape. In addition, the number of supporting portions 22 is not particularly limited as long as the base portion 21 can be supported relative to the substrate 11.

In the light-emitting device 100 of the embodiment, the supporting portions 22 may be formed continuously over the four sides of the lower surface of the base portion 21. In this case, it is preferred that an opening that allows for the inflow of resin is provided to at least part of the supporting portions 22 to allow the uncured resin material that becomes the light-reflecting member 19 after curing to be filled into an interior enclosed by the supporting portions 22.

In the light-emitting device 100 of the embodiment, the optical function unit 17 is configured by integrally forming the base portion 21, the supporting portions 22, and the projecting portions 23. However, the optical function unit 17 is not limited to this. For example, the base portion 21, the supporting portions 22, and the projecting portions 23 may be molded separately, and these may be joined to one another to manufacture the optical function unit 17.

In the light-emitting device 100 of the embodiment, the phosphor unit 15 is formed on the upper surface of the light-emitting element 13. However, the phosphor unit 15 need not necessarily be disposed. For example, if only blue light is emitted outward from the light-emitting device 100, only the light-emitting element 13 may be disposed on the substrate 11.

In the light-emitting device 100 of the embodiment, the projecting portions 23 are disposed on the base portion 21 of the optical function unit 17. However, it is only necessary to allow light to pass through, and a projecting portion 23 need not necessarily be disposed. In addition, as described above, the number of the projecting portions 23 may be nine or more or nine or less. For example, in one form, one projecting portion 23 may be arranged so as to cover the upper surface 15T of the phosphor unit 15.

In the light-emitting device 100 of the embodiment, the coating layer RE need not necessarily be formed on the upper surface 15T of the phosphor unit 15. That is, in one form, the upper surface 15T of the phosphor unit 15 may be exposed from the light-reflecting member 19.

In the light-emitting device 100 of the embodiment, the light-reflecting member 19 may be formed in advance on the side surfaces of the above-described middle part and upper part of the phosphor unit 15, and the phosphor unit 15 made into a cuboid shape as a whole may be disposed on the light-emitting element 13. Afterward, an additional light-reflecting member 19 may be formed to cover the already disposed light-reflecting member 19 and the lower part of the phosphor unit 15.

In the light-emitting device 100 of the embodiment, the light-reflecting member 19 and the light-reflecting member 24 may have a light-shielding property instead of a light reflectivity. That is, it is only necessary for the light-reflecting member 19 and the light-reflecting member 24 to have a configuration that can suppress the leakage of the light reaching the outer side surfaces of the light-emitting element 13, the phosphor unit 15, and the base portion 21 to the outside of the light-emitting device 100. In addition, the side surfaces of the light-reflecting member 19 and the side surfaces of the substrate 11 may be formed to become the side surfaces of the light-emitting device 100 without having the frame body portion 11B.

### Method for Manufacturing Light-Emitting Device 100

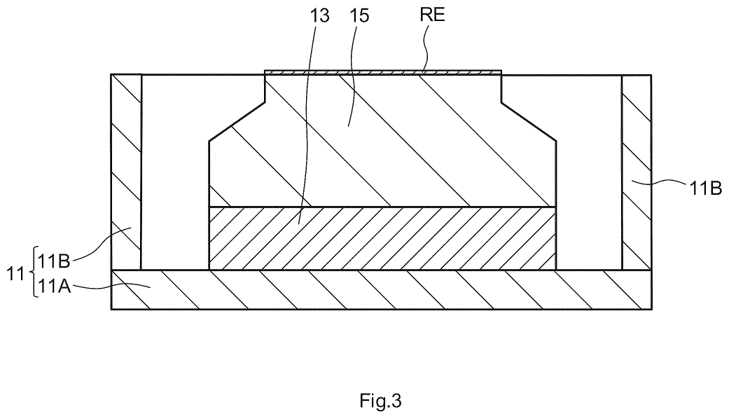

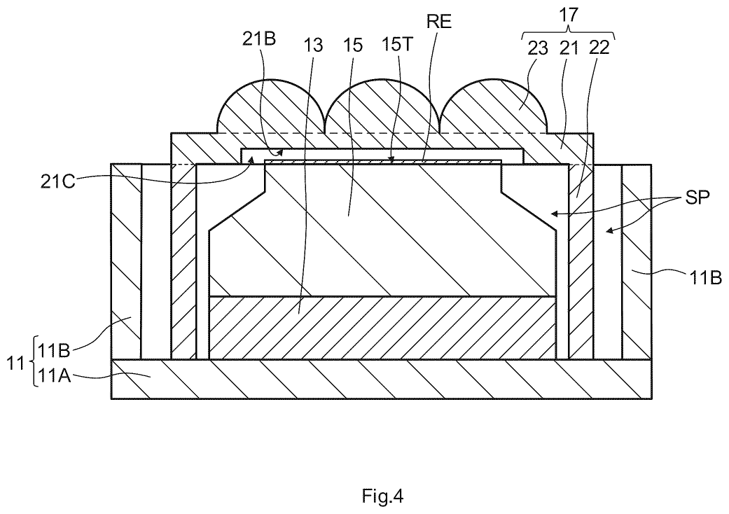

Here, using FIG. 3 and FIG. 4, a method for manufacturing the light-emitting device 100 according to the embodiment is described. FIG. 3 and FIG. 4 are cross-sectional views illustrating an exemplary manufacturing process of the light-emitting device 100. The following describes, in particular, the joining of the optical function unit 17 to the substrate 11 and the formation of the light-reflecting member 19.

First, as illustrated in FIG. 3, the light-emitting element 13 is mounted on the upper surface of the bottom portion 11A of the substrate 11, and the phosphor unit 15 with a coating layer RE formed on the upper surface in advance is disposed on the mounted light-emitting element 13. The light-emitting element 13 and the phosphor unit 15 are bonded with a transparent adhesive, for example, as described above.

Next, as illustrated in FIG. 4, the supporting portions 22 of the optical function unit 17 are joined to the surrounding regions of the region of the upper surface of the bottom portion 11A of the substrate 11 using an adhesive where the light-emitting element 13 is mounted. At this time, the optical function unit 17 is arranged so that the projecting portions 23 of the optical function unit 17 cover the entire upper surface 15T of the phosphor unit 15 in the top view.

Next, the light-reflecting member 19 is formed by filling an uncured resin material that becomes the light-reflecting member 19 after curing into space SP in the recessed portion of the substrate 11, except for the light-emitting element 13, the phosphor unit 15, and the supporting portions 22 of the optical function unit 17, and heating and curing the uncured resin material.

Finally, the light-reflecting member 24 is formed in a region of the upper surface of the light-reflecting member 19 on the outer side with respect to the base portion 21 so as to cover the outer side surface of the base portion 21. The light-reflecting member 24 is formed, for example, by arranging an uncured resin material that becomes the light-reflecting member 24 after curing by potting and then heating and curing the resin material, or by molding with a mold, and the like.

### Modification 1

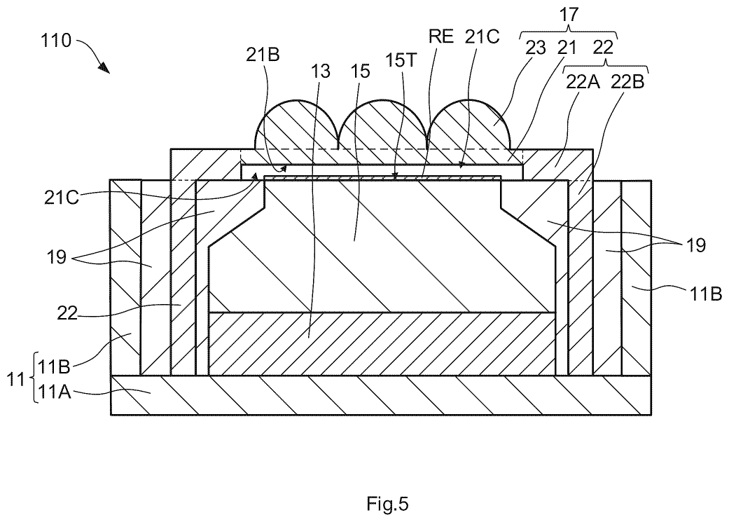

The following describes Modification 1 of Embodiment 1 using FIG. 5. FIG. 5 is a cross-sectional view of a light-emitting device 110 according to Modification 1. The light-emitting device 110 includes an optical function unit 17 with a configuration different from that of the light-emitting device 100 of Embodiment 1, and is otherwise similar to the light-emitting device 100.

In the light-emitting device 110 of the modification, the optical function unit 17 is constituted of a flat plate-shaped base portion 21, supporting portions 22 disposed on respective side surfaces of the base portion 21 opposed to one another, and a plurality of projecting portions 23 disposed on the upper surface of the base portion 21.

In the light-emitting device 110 of the modification, the supporting portion 22 of the optical function unit 17 is constituted of a first part 22A extending laterally from the side surface of the base portion 21, and a second part 22B extending from a region along an outer edge of a lower surface of the first part 22A toward the bottom portion 11A of the substrate 11.

In the light-emitting device 110 of the modification, the first part 22A has a flat-plate shape, and the second part 22B has a flat-plate shape perpendicular to a main surface of the first part 22A. Therefore, the supporting portion 22 has an L-shaped cross-sectional shape.

In the light-emitting device 110 of the modification, the first part 22A of the supporting portion 22 has an upper surface positioned at the same height as the upper surface of the base portion 21 and has a thickness greater than the base portion 21. Therefore, in the light-emitting device 110, the recessed portion 21C is formed by the lower surface of the base portion 21 and the inner side surfaces of the first parts 22A of the supporting portions 22.

In the modification, the second part 22B of the supporting portion 22 is joined to the upper surface of the bottom portion 11A of the substrate 11. Therefore, with the light-emitting device 110 of the modification, similarly to Embodiment 1, the optical function unit 17 can be stably disposed, and the desired light can be obtained.

### Modification 2

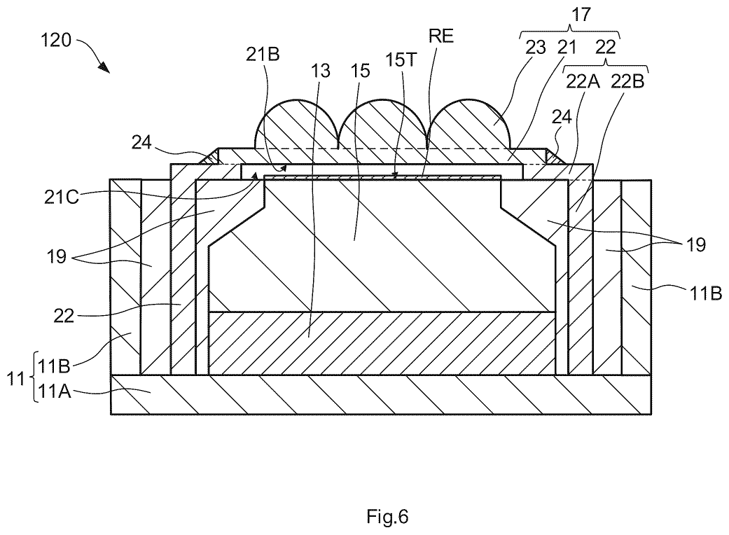

The following describes Modification 2 of Embodiment 1 using FIG. 6. FIG. 6 is a cross-sectional view of a light-emitting device 120 according to Modification 2. The light-emitting device 120 includes an optical function unit 17 with a configuration different from that of the light-emitting device 100 of Embodiment 1, and is otherwise similar to the light-emitting device 100.

In the light-emitting device 120 of the modification, the optical function unit 17 is constituted of a flat plate-shaped base portion 21, supporting portions 22 disposed in regions along the outer edge of the lower surface of the base portion 21, and a plurality of projecting portions 23 disposed on the upper surface of the base portion 21.

In the light-emitting device 120 of the modification, the supporting portion 22 of the optical function unit 17 is constituted of a first part 22A extending laterally from the region along the outer edge of the lower surface of the base portion 21, and a second part 22B extending from the region along the outer edge of the lower surface of the first part 22A toward the bottom portion 11A of the substrate 11.

In the light-emitting device 120 of the modification, the first part 22A has a flat-plate shape, and the second part 22B has a flat-plate shape perpendicular to the main surface of the first part 22A. Therefore, the supporting portion 22 has an L-shaped cross-sectional shape.

In the light-emitting device 120 of the modification, a recessed portion 21C is formed by the lower surface of the base portion 21 and the inner side surfaces of the first parts 22A of the supporting portions 22. Note that in the light-emitting device 120 of the modification, similarly to Embodiment 1, a frame-shaped light-reflecting member 24 with a light reflectivity is formed on the side surfaces of the base portion 21.

In the modification, the second part 22B of the supporting portion 22 is joined to the upper surface of the bottom portion 11A of the substrate 11. Therefore, with the light-emitting device 120 of the modification, similarly to Embodiment 1, the optical function unit 17 can be stably disposed, and the desired light can be obtained.

The light-reflecting member 24 may be continuously formed from the side surfaces of the base portion 21 to end portions of the upper surfaces of the first parts 22A, and in addition to this, it may be continuously formed on the upper surface of the light-reflecting member 19 or the upper surface of the frame body portion 11B. This allows the light guided to the supporting portions 22 (stray light) to be reflected, for example, in a direction of the projecting portions 23 to improve the optical output.

### Modification 3

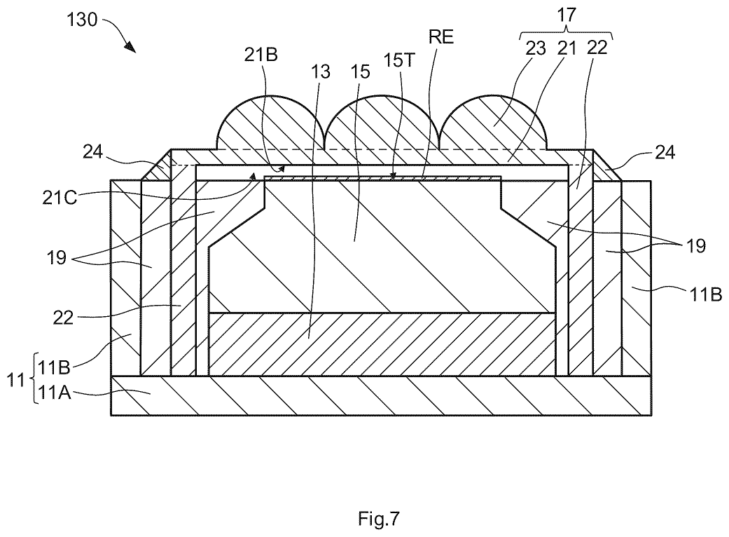

The following describes Modification 3 of Embodiment 1 using FIG. 7. FIG. 7 is a cross-sectional view of a light-emitting device 130 according to Modification 3. The light-emitting device 130 includes an optical function unit 17 with a configuration different from that of the light-emitting device 100 of Embodiment 1, and is otherwise similar to the light-emitting device 100.

In the light-emitting device 130 of the modification, the optical function unit 17 is constituted of a flat plate-shaped base portion 21, supporting portions 22 disposed in regions along the outer edge of the lower surface of the base portion 21, and a plurality of projecting portions 23 disposed on the upper surface of the base portion 21.

In the light-emitting device 130 of the modification, the supporting portions 22 of the optical function unit 17 extend downward from the regions along the outer edge of the lower surface of the base portion 21 toward the bottom portion 11A. Therefore, the supporting portions 22 are connected to the lower surface of the base portion 21 only at parts of the supporting portions 22 exposed from the light-reflecting member 19.

In the light-emitting device 130 of the modification, a recessed portion 21C is formed by the lower surface of the base portion 21 and the parts of the supporting portions 22 exposed from the light-reflecting member 19. Note that in the light-emitting device 130 of the modification, similarly to Embodiment 1, a frame-shaped light-reflecting member 24 is formed over the side surfaces of the base portion 21 and side surfaces of the parts of the supporting portions 22 exposed from the light-reflecting member 19.

In the modification, the supporting portions 22 are joined to the upper surface of the bottom portion 11A of the substrate 11, similarly to Embodiment 1. Therefore, with the light-emitting device 130 of the modification, similarly to Embodiment 1, the optical function unit 17 can be stably disposed, and the desired light can be obtained.

### Modification 4

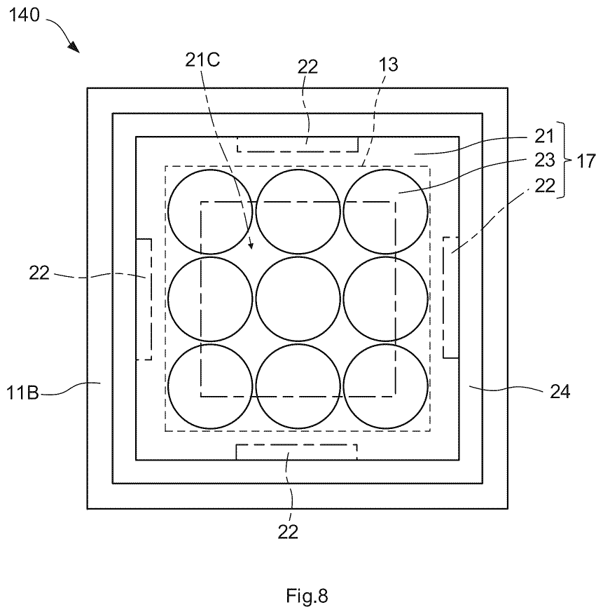

The following describes Modification 4 of Embodiment 1 using FIG. 8. FIG. 8 is a top view of a light-emitting device 140 according to Modification 4. The light-emitting device 140 includes supporting portions 22 of the optical function unit 17 with a formation configuration different from that of the light-emitting device 100 of Embodiment 1, and is otherwise similar to the light-emitting device 100.

In the light-emitting device 140 of the modification, as illustrated in FIG. 8, each of the supporting portions 22 of the optical function unit 17 is disposed in a central region of each side in a region along the outer edge of the lower surface of the base portion 21. That is, one supporting portion 22 is disposed on each side of the lower surface of the base portion 21 so that the supporting portions 22 are opposed to one another in the up-down direction and the left-right direction in the drawing.

Also in the modification, the supporting portions 22 are joined to the upper surface of the bottom portion 11A of the substrate 11, similarly to Embodiment 1. Therefore, with the light-emitting device 140 of the modification, similarly to Embodiment 1, the optical function unit 17 can be stably disposed, and the desired light can be obtained.

### Modification 5

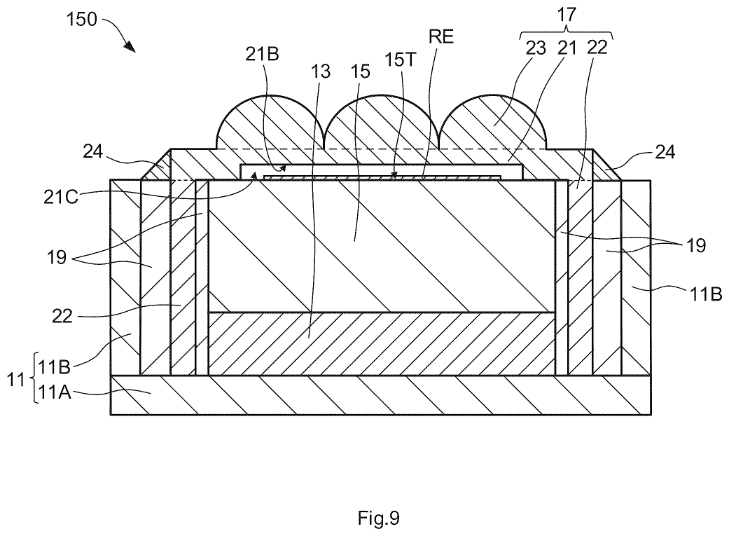

The following describes Modification 5 of Embodiment 1 using FIG. 9. FIG. 9 is a cross-sectional view of a light-emitting device 150 according to Modification 5. The light-emitting device 150 includes a phosphor unit 15 with a shape different from that of the light-emitting device 100 of Embodiment 1, and is otherwise similar to the light-emitting device 100.

In the light-emitting device 150 of the modification, the phosphor unit 15 is a cuboid-shaped phosphor layer having a rectangular upper surface shape. In the form of the light-emitting device 150 of the modification, the base portion 21 of the optical function unit 17 is disposed such that part of the lower surface of the base portion 21 is in contact with the upper surface 15T of the phosphor unit 15.

Also in the modification, the supporting portions 22 are joined to the upper surface of the bottom portion 11A of the substrate 11, similarly to Embodiment 1. Therefore, with the light-emitting device 150 of the modification, similarly to Embodiment 1, the optical function unit 17 can be stably disposed, and the desired light can be obtained.

Note that in the light-emitting device 150 of the modification, the coating layer RE is formed in the central region of the upper surface 15T of the phosphor unit 15, but a size of the coating layer RE can be changed, as necessary. For example, the coating layer RE may be formed over the entire upper surface 15T of the phosphor unit 15.

### Modification 6

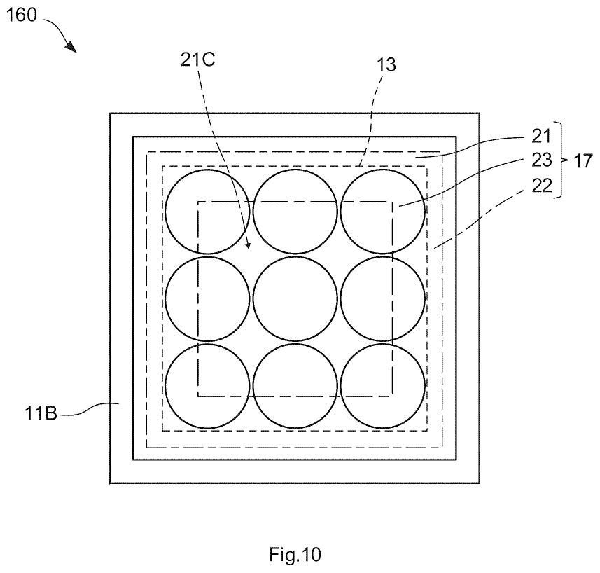

The following describes Modification 6 of Embodiment 1 using FIG. 10. FIG. 10 is a top view of a light-emitting device 160 according to Modification 5. The light-emitting device 160 is different from the light-emitting device 100 of Embodiment 1 in that it includes an optical function unit 17 with a different configuration and that the light-reflecting member 19 is not formed, and is otherwise similar to the light-emitting device 100.

In the light-emitting device 160 of the modification, a supporting portion 22 of the optical function unit 17 has a frame-shaped upper surface shape. That is, in the light-emitting device 160, the light-emitting element 13 and the phosphor unit 15 are enclosed by the supporting portion 22 of the optical function unit 17.

In addition, in the form of the light-emitting device 160 of the modification, the light-reflecting member 19 is not formed in the recessed portion of the substrate 11. Therefore, the light emitted from the light-emitting element 13 and the phosphor unit 15 and reaching the respective side surfaces of the light-emitting element 13 and the phosphor unit 15 is emitted outward from the side surfaces.

In the light-emitting device 160 of the modification, the supporting portion 22 with a light reflectivity encloses the side surfaces of the light-emitting element 13 and the phosphor unit 15. Therefore, the light emitted outward from the respective side surfaces of the light-emitting element 13 and the phosphor unit 15 is reflected or scattered by the supporting portion 22.

Accordingly, in the light-emitting device 160 of the modification, even though the light-reflecting member 19 is not formed in the recessed portion of the substrate 11, it is possible to suppress the leakage of the light emitted from the side surfaces of the light-emitting element 13 and the phosphor unit 15 to the outside of the light-emitting device 160.

Also in the modification, the supporting portion 22 is joined to the upper surface of the bottom portion 11A of the substrate 11, similarly to Embodiment 1. Therefore, with the light-emitting device 160 of the modification, similarly to Embodiment 1, the optical function unit 17 can be stably disposed, and the desired light can be obtained.

### Application Example of Light-Emitting Device 100

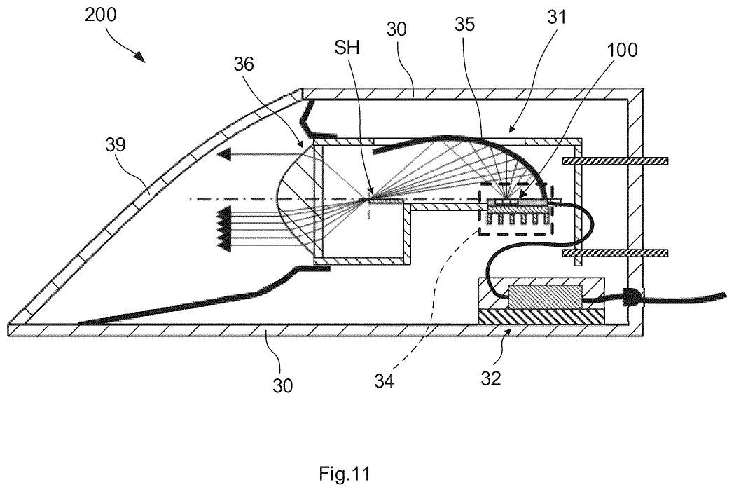

The following describes an application example of the light-emitting device 100 of Embodiment 1 using FIG. 11. FIG. 11 is a cross-sectional view of a lighting apparatus 200 as an application example of the light-emitting device 100. The lighting apparatus 200 is, for example, a vehicle lighting apparatus used for vehicle headlights.

The lighting apparatus 200 is configured to include a housing 30, as well as a lamp unit 31 and a power supply unit 32 arranged in the housing 30. The lamp unit 31 is configured to include a light-emitting module 34 including a light-emitting device 100, a light-collecting mirror 35, and a projection lens 36.

In the lighting apparatus 200, the light-emitting device 100 is supplied with electric power from the power supply unit 32 and emits light (diffused light) upward in the drawing. The light emitted outward from the light-emitting device 100 enters the light-collecting mirror 35 and is concentrated into one focal point by the light-collecting mirror 35.

The lamp unit 31 has a shade SH to form a beam distribution for passing (what is called low beam or high beam) in automotive headlights. The shade SH is configured to partially reflect the light concentrated by the light-collecting mirror 35 toward the projection lens 36.

The light passing through the projection lens 36 via the shade SH is emitted outward to the outside of the lighting apparatus 200 through a translucent outer lens 39 disposed in the housing 30. By thus incorporating the light-emitting device 100 of the embodiment into the lighting apparatus 200, it is possible to use the light with narrow-angle light distribution as described above.

The projection type optical system in which light is concentrated into the projection lens 36 by the light-collecting mirror 35 and irradiated has been described above. However, a direct projection type (also referred to as a direct-irradiation type) optical system (not illustrated) may be used. The direct projection type optical system is an optical system in which light from the light-emitting device 100 directly enters a projection lens, not via the light-collecting mirror 35.

It is understood that the foregoing description and accompanying drawings set forth the preferred embodiments of the present invention at the present time. Various modifications, additions and alternative designs will, of course, become apparent to those skilled in the art in light of the foregoing teachings without departing from the spirit and scope of the disclosed invention. Thus, it should be appreciated that the present invention is not limited to the disclosed Examples but may be practiced within the full scope of the appended claims. The present application is based upon and claims the benefit of priority from the prior Japanese Patent Application No. 2024-204505 filed on Nov. 25, 2024, the entire contents of which are incorporated herein by reference.

### DESCRIPTION OF REFERENCE SIGNS

100, 110, 120, 130, 140, 150, 160 Light-emitting device
200 Lighting apparatus
11 Substrate
13 Light-emitting element
15 Phosphor unit
17 Optical function unit
19, 24 Light-reflecting member
21 Base portion
22 Supporting portion
23 Projecting portion

What is claimed is:

1. A light-emitting device comprising:
a substrate;
a light-emitting unit including a light-emitting element that is arranged on the substrate and includes a light-emitting layer, a light emitted from the light-emitting layer being emitted outward from an upper surface of the light-emitting unit;
an optical function unit including a base portion and a supporting portion, the base portion being disposed to form a void between the base portion and the upper surface of the light-emitting unit and having an optical element structure that allows a light emitted outward from the light-emitting unit to pass therethrough, the supporting portion extending from the base portion to a surrounding region of a region where the light-emitting element is arranged; and
a light-reflecting unit having a light reflectivity or a light-shielding property and covering a side surface of the light-emitting unit and a surface of the supporting portion on the substrate.

2. The light-emitting device according to claim 1, wherein
the supporting portion has a light reflectivity.

3. The light-emitting device according to claim 2, wherein
the supporting portion is formed of a material containing titanium oxide particles in a transparent silicone resin.

4. The light-emitting device according to claim 1, wherein
the base portion includes a recessed portion at a center of a lower surface of the base portion, the center being recessed relative to a periphery thereof, and a bottom surface of the recessed portion is separated from the upper surface of the light-emitting unit.

5. The light-emitting device according to claim 1, wherein
the supporting portion is a supporting body extending above the upper surface of the light-emitting unit and supports the base portion to separate the upper surface of the light-emitting unit from a lower surface of the base portion.

6. The light-emitting device according to claim 1, wherein
the supporting portion reaches two regions located to sandwich a region of an upper surface of the substrate where the light-emitting unit is arranged.

7. The light-emitting device according to claim 1, wherein
the base portion includes a lens formed on an upper surface of the base portion.

8. The light-emitting device according to claim 1, wherein
the light-emitting unit includes a phosphor unit formed on the light-emitting element and including a phosphor that is excited by the light emitted from the light-emitting layer to emit fluorescence.

9. The light-emitting device according to claim 8, wherein
a translucent coating layer is formed on an upper surface of the phosphor unit.

10. A light-emitting device comprising:
a substrate;
a light-emitting unit including a light-emitting element that is arranged on the substrate and includes a light-emitting layer, a light emitted from the light-emitting layer being emitted outward from an upper surface of the light-emitting unit; and
an optical function unit including a base portion and a supporting portion having a light reflectivity, the base portion being disposed to form a void between the base portion and the upper surface of the light-emitting unit and having an optical element structure that allows a light emitted outward from the light-emitting unit to pass therethrough, the supporting portion extending from the base portion to a surrounding region of a region of an upper surface of the substrate where the light-emitting unit is arranged.

11. A lighting apparatus comprising:
a light-emitting module that includes a light-emitting device and a projection lens, the light-emitting device including a substrate, a light-emitting unit, an optical function unit, and a light-reflecting unit, the light-emitting unit including a light-emitting element that is arranged on the substrate and includes a light-emitting layer, a light emitted from the light-emitting layer being emitted outward from an upper surface of the light-emitting unit, the optical function unit including a base portion and a supporting portion, the base portion including a recessed portion at a center of a lower surface of the base portion, the center being recessed relative to a periphery thereof, the base portion being disposed to form a void between the base portion and the upper surface of the light-emitting unit by separating a bottom surface of the recessed portion from the upper surface of the light-emitting unit, the base portion having an optical element structure that allows a light emitted outward from the light-emitting unit to pass therethrough, the supporting portion extending from the base portion to a surrounding region of a region where the light-emitting element is arranged, the light-reflecting unit having a light reflectivity and covering a side surface of the light-emitting unit on the substrate, the projection lens distributing the light emitted outward from the light-emitting device; and
a housing including an outer lens that covers the light-emitting module and allows the light emitted outward from the light-emitting device to pass therethrough.

12. The lighting apparatus according to claim 11, comprising
a phosphor unit formed on the light-emitting element and including a phosphor that is excited by the light emitted from the light-emitting layer to emit fluorescence.
